(19) United States
(12) Patent Application Publication
(10) Pub. No.: US 2014/0112610 A1
(43) Pub. Date: Apr. 24, 2014

(54) SEMICONDUCTOR OPTICAL MODULATOR

(71) Applicant: Mitsubishi Electric Corporation, Tokyo (JP)

(72) Inventor: Kazuhisa Takagi, Tokyo (JP)

(21) Appl. No.: 13/905,192

(22) Filed: May 30, 2013

(30) Foreign Application Priority Data
Oct. 23, 2012 (JP) 2012-234010

(51) Int. Cl. G02F 1/017

(52) U.S. Cl. CPC G02F 1/01708
USPC 385/2

(57) ABSTRACT

A semiconductor optical modulator includes a substrate, which has a first conductivity type, and a first electrode on a first main surface of the substrate. A first cladding layer having the first conductivity type, a transparent waveguide layer, a second cladding layer having the first conductivity type, an optical-absorption layer, and a third cladding layer having a second conductivity type, are sequentially laminated on a second main surface of the substrate. A ridge part is formed by removing a part of the third cladding layer and a part of the second cladding layer in a laminated direction. A second electrode on the ridge part is electrically connected to the third cladding layer.

### CROSS-REFERENCE TO RELATED APPLICATION

This application claims priority from Japanese Patent Application No. 2012-234010 filed on Oct. 23, 2012, the entire subject matter of which is incorporated herein by reference.

### TECHNICAL FIELD

This disclosure relates to an electro-absorption semiconductor optical modulator that is used in an optical transmitter for optical fiber communication and the like.

### BACKGROUND

As a light source of an optical transmitter for optical fiber communication for high speed/long distance, an optical modulator integrated semiconductor laser is useful in which a semiconductor laser and a semiconductor optical modulator are monolithically integrated. In an optical modulator unit of the optical modulator integrated semiconductor laser, an electro-absorption optical modulator is used. As a waveguide structure thereof, a high-mesa ridge type, where a core layer (optical waveguide layer) is provided at an inner side of a ridge, or a low-mesa ridge type, where a core layer is provided below a ridge is adopted (for example, refer to JP-A-2008-10484 (paragraphs [0038] to [0039] and FIG. 2 of JP-A-2008-10484)).

### SUMMARY

According to the electro-absorption optical modulator having the low-mesa ridge structure, a strong electric field is applied to the optical waveguide layer below the ridge by applying a negative voltage to an anode part. As a result, an optical-absorption coefficient of the optical waveguide layer is increased by the Quantum Confined Stark Effect, so that a light quenching operation is made. In this structure, since the optical waveguide layer also serves as an optical-absorption layer, the optical-absorption coefficient of the largest area of a light distribution is made to be largest. In general, the light has a property of propagating toward an area having a small optical-absorption coefficient while avoiding an area having a large optical-absorption coefficient. Accordingly, the unimodality of light that is propagated through the waveguide of the optical modulator breaks down, and then a shape of the laser light that is emitted from the optical modulator is not unimodal.

In view of the above, this disclosure provides at least a semiconductor optical modulator where a shape of emitted laser light is unimodal.

A semiconductor optical modulator of this disclosure includes: a substrate, which has a first conductivity type, and which includes a first electrode formed on a first main surface thereof; a first clad layer having the first conductivity type, a transparent waveguide layer, a second clad layer having the first conductivity type, an optical-absorption layer, and a third clad layer having a second conductivity type, which are sequentially laminated on a second main surface of the substrate from the substrate; a ridge part, which is formed by removing the third clad layer and a part of the second clad layer in a laminated direction, and a second electrode, which is formed on the ridge part and is connected to the third clad layer.

According to this disclosure, since an optical-absorption area exists at an end of a light distribution, it is possible to obtain a semiconductor optical modulator where a shape of emitted laser light is unimodal.

### BRIEF DESCRIPTION OF THE DRAWINGS

The foregoing and additional features and characteristics of this disclosure will become more apparent from the following detailed descriptions considered with the reference to the accompanying drawings, wherein:

FIG. 1A is a perspective view illustrating a semiconductor laser according to a first illustrative embodiment of this disclosure, and FIG. 1B illustrates a light distribution at a light emission point;

FIG. 2 is a perspective view illustrating a semiconductor laser according to a second illustrative embodiment of this disclosure;

FIG. 3 is a perspective view illustrating the semiconductor laser according to the second illustrative embodiment of this disclosure;

FIG. 4 is a perspective view illustrating a semiconductor laser according to a third illustrative embodiment of this disclosure;

FIG. 5 is a perspective view illustrating a semiconductor laser according to a fourth illustrative embodiment of this disclosure;

FIG. 6 is a perspective view illustrating a semiconductor laser according to a fifth illustrative embodiment of this disclosure;

FIG. 7 illustrates a relation between a horizontal/vertical transverse mode and an optical-absorption area of the background art;

FIGS. 8A and 8B illustrate relations between horizontal/vertical transverse modes and optical-absorption areas; and

FIG. 9 is a perspective view illustrating a semiconductor optical modulator of the background art.

### DETAILED DESCRIPTION

A semiconductor optical modulator according to illustrative embodiments of this disclosure will be described with reference to the drawings. The same or corresponding elements are denoted with the same reference numerals and the overlapping descriptions may be omitted.

### First Illustrative Embodiment

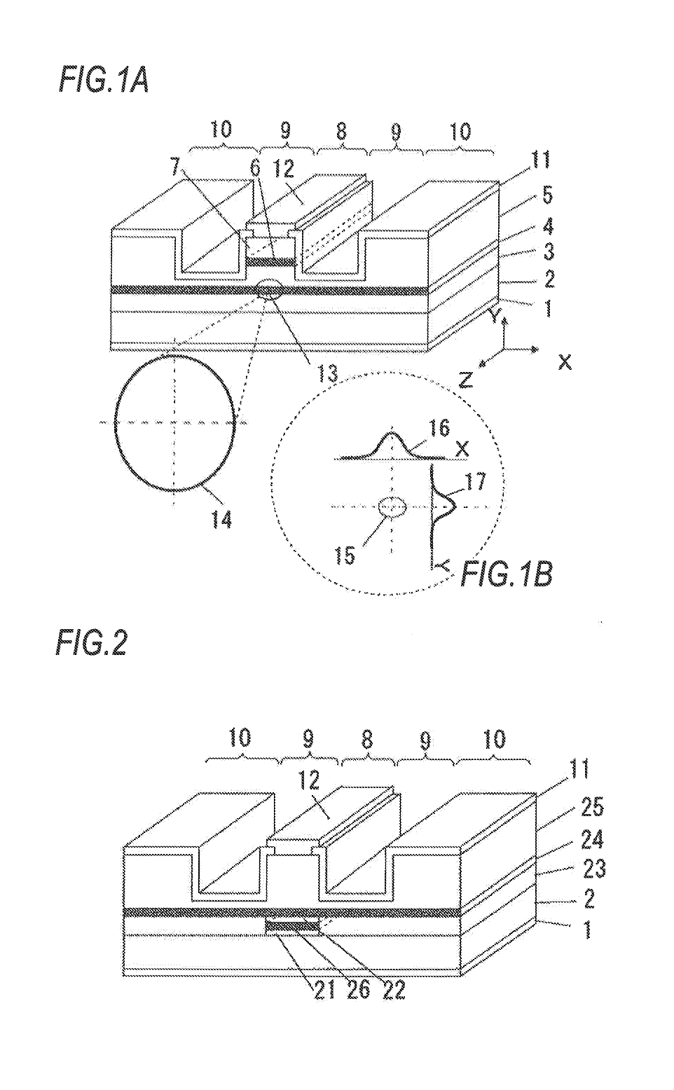

FIG. 1A is a perspective view illustrating an optical modulator integrated semiconductor laser according to a first illustrative embodiment of this disclosure. In FIG. 1A, a reference numerals 1 indicates an n electrode made of Ti/Pt/Au, a reference numerals 2 indicates a substrate made of n-type InP, a reference numerals 3 indicates a first clad layer made of n-type InP, a reference numerals 4 indicates a transparent waveguide layer made of Multi Quantum Well (MQW), a reference numerals 5 indicates a second clad layer made of n-type InP, a reference numerals 6 indicates an optical-absorption layer made of Multi Quantum Well (MQW), a reference numerals 7 indicates a third clad layer made of p-type InP, a reference numerals 8 indicates a ridge part, a reference numerals 9 indicates a channel part, a reference numerals 10 indicates a pedestal part, a reference numerals 11 indicates an insulation film made of SiO₂, and a reference numerals 12 indicates a p electrode made of Ti/Pt/Au. The Multi Quantum Well is an InGaAsP-MQW in which an undoped InGaAsP well layer and an undoped InGaAsP barrier layer are alternately stacked. However, this disclosure is not limited thereto. For example, AlGaInAs-MQW and the like may be also used. In the meantime, the semiconductor laser is formed at the rear of the optical modulator in the drawing (not shown) so that it is close to the optical modulator.

FIG. 1B shows a light distribution 15 at a light emission point 13 from which a laser light 14 is emitted. The light distribution 15 at the light emission point 13 is referred to as a near-field image and has an elliptical shape as shown. The near-field image is evaluated with being divided in a horizontal direction (X direction) and a vertical direction (Y direction), which are respectively referred to as a horizontal transverse mode 16 and a vertical transverse mode 17.

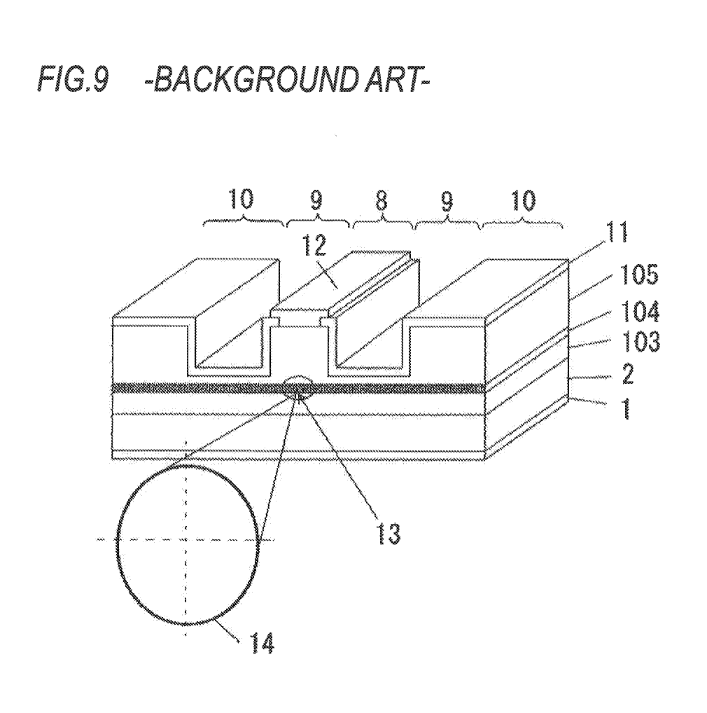

For comparison, FIG. 9 shows a perspective view illustrating an optical modulator of the background art. In FIG. 9, a reference numeral 103 indicates a clad layer made of n-type InP, a reference numeral 104 indicates an optical-absorption layer made of Multi Quantum Well (MQW) and a reference numeral 105 indicates a clad layer made of p-type InP.

In the optical modulator of this disclosure, the transparent waveguide layer 4 is provided at the position of the optical-absorption layer 104 of the optical modulator of the background art, and the transparent waveguide layer 4 is sandwiched between the n-type semiconductor layers. Also, the optical-absorption layer 6 is positioned above the transparent waveguide layer 4 and is sandwiched between the n-type and p-type semiconductor layers (the second clad layer 5 and the third clad layer 7).

In order to manufacture the optical modulator of this illustrative embodiment, the first clad layer 3, the transparent waveguide layer 4, the second clad layer 5, the optical-absorption layer 6 and the third clad layer 7 are laminated and grown on the n-type InP substrate 2 by a MOCVD method. Then, the channel 9 is etched to form the ridge part 8 and the pedestal part 9 by a wet etching and the like. Subsequently, the insulation film 11, the n electrode 1 and the p electrode 12 are formed to manufacture the optical modulator.

In the below, operations are described. The laser light emitted from the semiconductor laser is incident (not shown) onto the transparent waveguide layer 4 from the rear of FIG. 1A and propagates in a z direction from the transparent waveguide layer 4 serving as a core layer. When a negative voltage is applied to the p electrode 12, the optical-absorption layer 6 sandwiched between the n-type and p-type semiconductor layers (the second clad layer 5 and the third clad layer 7) is applied with an electric field and an optical-absorption coefficient is thus increased, so that the optical-absorption layer 6 absorbs the laser light. Since the transparent waveguide layer 4 is sandwiched between the n-type semiconductor layers (the first clad layer 3 and the second clad layer 5), the transparent waveguide layer 4 is not applied with an electric field, so that it does not absorb the laser light.

Meanwhile, as shown in FIG. 8A, a center of the vertical transverse mode 17 is in the transparent waveguide layer 4, and an optical-absorption area 18 (optical-absorption layer 6) exists at an end of the vertical transverse mode 17. Therefore, the unimodality of the light distribution 18 scarcely breaks down, so that a shape of the emitted laser light 14 is not degraded.

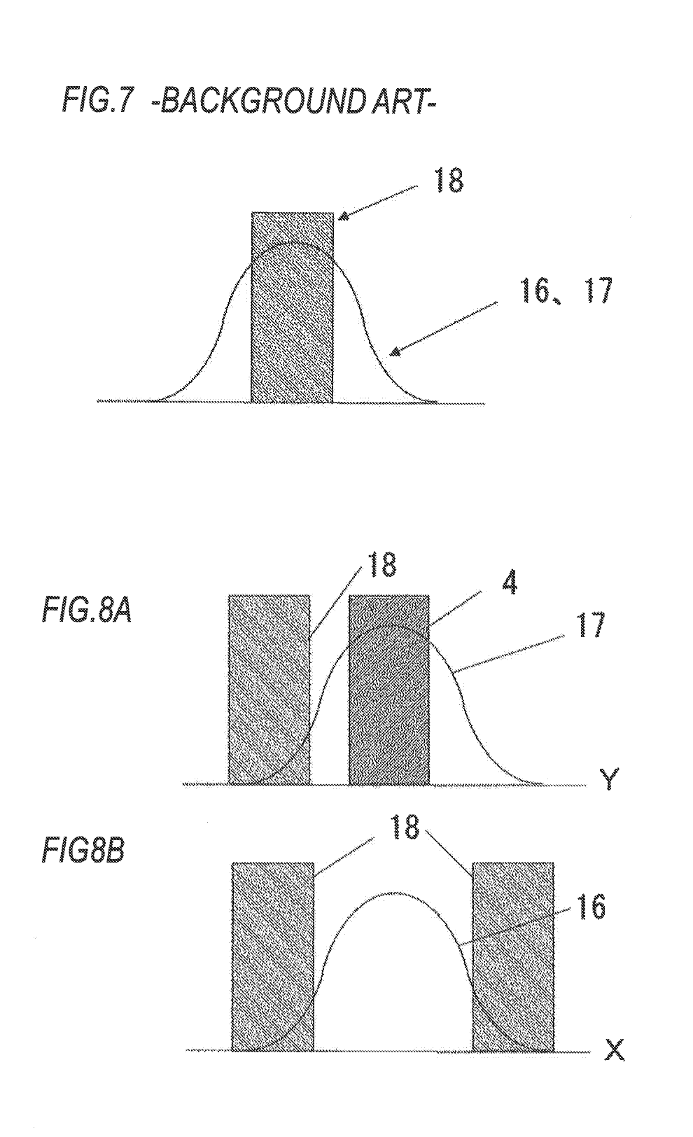

On the other hand, according to the optical modulator of the background art, as shown in FIG. 7, the centers of the horizontal transverse mode 16 and vertical transverse mode 17 are in the optical-absorption area 18 (optical-absorption layer 104), and thus the optical-absorption coefficient is large. Accordingly, the light intends to propagate towards both sides having smaller optical-absorption coefficients while avoiding the area having the larger optical-absorption coefficient. Thereby, the unimodality of the light distribution breaks down, so that a shape of the emitted laser light 14 is degraded.

According to this illustrative embodiment, since the optical-absorption area exists at the end of the light distribution propagating through the optical waveguide, it is possible to implement a light quenching operation without breaking down the unimodality of the light distribution 15. Therefore, it is possible to obtain the optical modulator where the shape of the emitted laser light 14 is kept unimodal.

### Second Illustrative Embodiment

FIG. 2 is a perspective view illustrating an optical modulator according to a second illustrative embodiment. In FIG. 2, a reference numeral 21 indicates a clad layer made of n-type InP, a reference numeral 26 indicates an optical-absorption layer made of Multi Quantum Well and a reference numeral 22 indicates a clad layer made of p-type InP. Also, a reference numeral 23 indicates a buried layer made of undoped InP, a reference numeral 24 indicates a transparent waveguide layer and a reference numeral 25 indicates a clad layer made of p-type InP.

In the second illustrative embodiment, the optical-absorption layer 26 is provided in the clad layer below the transparent waveguide 24 and is sandwiched between the n-type semiconductor (clad layer 21) and the p-type semiconductor (clad layer 22).

In order to manufacture the optical modulator of this illustrative embodiment, the n-type InP clad layer 21, the MQW optical-absorption layer 26 and the p-type InP clad layer 22 are laminated and grown on the n-type InP substrate 2 by the MOCVD method. Then, a ridge stripe pattern is formed by a wet etching and the like and the undoped InP buried layer 23 is buried and grown at both sides of the ridge stripe. Subsequently, the transparent waveguide layer 24 and the p-type InP clad layer 25 are laminated and grown by the MOCVD, and then the ridge part 8 is formed by the same method as the first illustrative embodiment.

Also in the optical modulator of this illustrative embodiment, the same effects as the first illustrative embodiment are obtained. Also, since a capacitance is reduced by the buried layer 23, it is possible to obtain the optical modulator having excellent high-speed responsiveness.

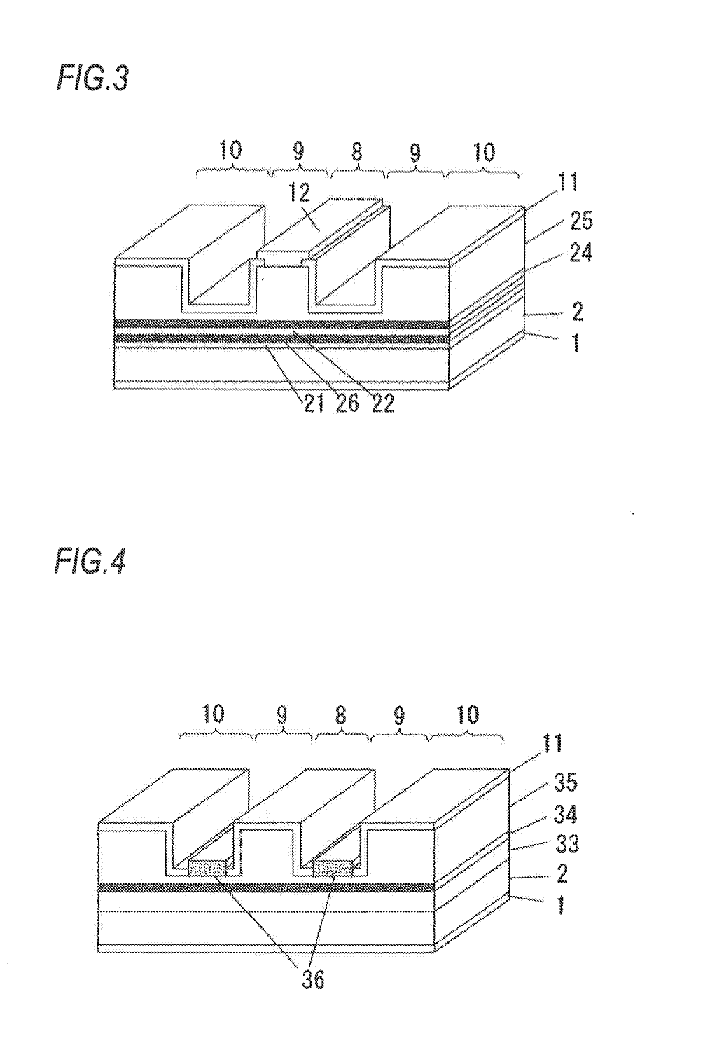

Meanwhile, in this illustrative embodiment, the buried layer 23 is used. However, as shown in FIG. 3, a configuration where the buried layer 23 is not provided may be also used.

### Third Illustrative Embodiment

FIG. 4 is a perspective view illustrating an optical modulator according to a third illustrative embodiment. In FIG. 4, a reference numeral 33 indicates a clad layer made of n-type InP, a reference numeral 34 indicates a transparent waveguide layer made of Multi Quantum Well (MQW), a reference numeral 35 indicates a clad layer made of p-type InP and a reference numeral 36 indicates a p electrode, respectively.

The optical modulator of this illustrative embodiment has a configuration where the arrangement of the p electrode 12 is changed in the modulator having a structure shown in FIG. 9.

In the below, operations are described. The laser light emitted from the semiconductor laser is incident into the transparent waveguide layer 34 and propagates in the transparent waveguide layer 34 serving as a core layer. When a negative voltage is applied to the p electrode 36, the transparent waveguide layer 34 sandwiched between the n-type and p-type semiconductor layers (the clad layer 33 and the clad layer 35) is applied with an electric field and an optical-absorption coefficient is thus increased, so that the laser light is absorbed. At this time, the electric field is mainly applied to the transparent waveguide layer 34 just below the channel 9 and is not applied to the transparent waveguide layer 34 just below the ridge, so that the absorption area 18 is eccentrically distributed in the transparent waveguide layer 34 just below the channel 9. Therefore, as shown in FIG. 8B, the light is not absorbed at the center of the horizontal transverse mode 16, and the optical-absorption area 18 exists at both ends of the horizontal transverse mode 16. Accordingly, the unimodality of the light distribution 15 scarcely breaks down, so that the shape of the emitted laser light 14 is not degraded.

### Fourth Illustrative Embodiment

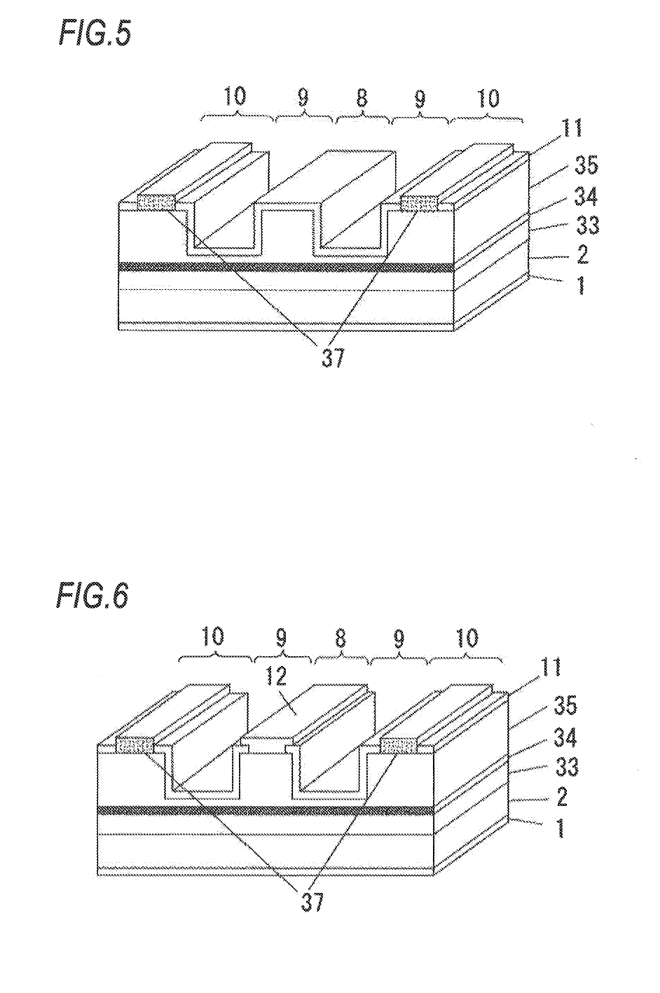

FIG. 5 is a perspective view illustrating an optical modulator according to a fourth illustrative embodiment. In FIG. 5, a reference numeral 37 indicates a p electrode, and an arrangement of p electrode 37 is changed the arrangement of the p electrode 36 in the third illustrative embodiment.

In the optical modulator of this illustrative embodiment, the electric field is mainly applied to the transparent waveguide layer 34 just below the pedestal 10 and is not applied to the transparent waveguide layer 34 just below the ridge, the absorption area 18 is eccentrically distributed in the transparent waveguide layer 34 just below the pedestal 10. Therefore, as shown in FIG. 8B, the light is not absorbed at the center of the horizontal transverse mode 16, and the optical-absorption area 18 exists at both ends of the horizontal transverse mode 16. Accordingly, the unimodality of the light distribution 15 scarcely breaks down, so that the shape of the emitted laser light 14 is not degraded.

### Fifth Illustrative Embodiment

FIG. 6 is a perspective view illustrating an optical modulator according to a fifth illustrative embodiment. FIG. 6 shows a configuration where the p electrode 12 is added to the optical modulator of FIG. 5. Instead of the configuration of FIG. 6, the p electrode 12 may be added to the optical modulator having the configuration of FIG. 4. The same effects as the first illustrative embodiment are obtained, and an effect of increasing the optical-absorption area to thus shorten a length of the optical modulator is also obtained.

Also, by independently controlling voltages to be applied to the three p electrodes, it is possible to obtain an effect of controlling the shape of the emitted laser light and an emission direction thereof.

In the above illustrative embodiments, the optical modulator integrated semiconductor laser has been exemplified. However, even when a single laser and a single semiconductor optical modulator are used, the same effects are obtained.

Although the n-type substrate has been exemplified, a p-type substrate may be also used. In this case, the conductivity types of the n-type and p-type may be reversed each other. Although the InP-based material has been exemplified as the semiconductor material, the other materials may be also used.

The configuration where the p electrode and the clad layer are directly connected has been illustrated. However, when the p electrode and the clad layer are connected with a contact layer being sandwiched between the p electrode and the clad layer, it is possible to form an ohmic electrode more securely.

1. A semiconductor optical modulator comprising:
a substrate having a first conductivity type and opposed first and second main surfaces;
a first electrode on the first main surface of the substrate;
a first cladding layer having the first conductivity type, a transparent waveguide layer, a second cladding layer having the first conductivity type, an optical-absorption layer, and a third cladding layer having a second conductivity type, sequentially laminated on the second main surface of the substrate in a laminating direction;
a ridge part, which is formed by removing a part of the third cladding layer and a part of the second cladding layer in the laminating direction; and
a second electrode on the ridge part and electrically connected to the third cladding layer.

2. A semiconductor optical modulator comprising:
a substrate having a first conductivity type and opposed first and second main surfaces;
a first electrode on the first main surface of the substrate;
a cladding layer having the first conductivity type, an optical-absorption layer, a second cladding layer having a second conductivity type, a transparent waveguide layer and a third cladding layer having the second conductivity, laminated on the second main surface of the substrate sequentially, in a laminating direction;
a ridge part, which is formed by removing a part of the third layer in in the laminating direction; and
a second electrode on the ridge part and electrically connected to the third layer.

3. The semiconductor optical modulator according to claim 2, wherein the first cladding layer, the optical-absorption layer and the second cladding layer, except for a part below the ridge part, are removed and then are buried with an undoped semiconductor layer.

4. A semiconductor optical modulator comprising:
a substrate having a first conductivity type and opposed first and second main surfaces;
a first electrode on the first main surface of the substrate;
a first cladding layer having the first conductivity type, a transparent waveguide layer and a second cladding layer having a second conductivity type, laminated on the second main surface of the substrate sequentially, in a laminating direction;
a ridge part, which is formed by removing a part of the second cladding layer in laminating direction;
a channel part sandwiching the ridge part;
a pedestal part located at an outer side of the channel part, and
one of a third electrode on the channel part and electrically connected to the second cladding layer on the channel part, and (ii) a fourth electrode on the pedestal part and electrically connected to the second cladding layer on the pedestal part.

5. The semiconductor optical modulator according to claim 4, further comprising a fifth electrode on the ridge part.
